(19) United States
(12) Patent Application Publication
(10) Pub. No.: US 2023/0249077 A1
(43) Pub. Date: Aug. 10, 2023

(54) COMPUTER SYSTEMS AND COMPUTER PROCESSING METHODS FOR COMPUTER BASED GAMES AND MATCHES

(71) Applicant: Deeds Technologies Pty Ltd, Sydney, New South Wales (AU)

(72) Inventors: Luke MILLANTA, Woolloomooloo (AU); Randall NOBLE, Moorebank (AU); Zhan WANG, Bondi (AU); Jun LI, Pennant Hills (AU)

(21) Appl. No.: 18/023,918

(22) PCT Filed: Aug. 25, 2021
(86) PCT No.: PCT/AU2021/050962

§ 371 Date: Feb. 28, 2023

Related U.S. Application Data
(60) Provisional application No. 63/074,135, filed on Sep. 3, 2020.
(60) Provisional application No. 63/187,123, filed on May 11, 2021.

(51) Int. Cl. A63F 13/60; A63F 13/79

(52) U.S. Cl. CPC A63F 13/60; A63F 13/79

(57) ABSTRACT

Apparatus, systems, computer-readable storage media, and methods for computer-based games and matches are disclosed. An example computer system for managing a prize that can be awarded based on an outcome of a game includes a data processing arrangement. The example data processing arrangement is arranged to: access historical game data, wherein the historical game data represents information about historical outcomes of the game; process the historical game data to generate probability data, wherein the probability data represents information about a plurality of discrete probabilities each of which is associated with a different future outcome of the game; and process the probability data to generate prize data, wherein the prize data represents at least one characteristic associated with the prize.

### TECHNICAL FIELD

This specification relates generally to the field of skill-based computer games and to the field of computer systems for managing a prize and has particular, but by no means exclusive, application to computer systems that allow electronic wagers to be placed on outcomes of real or fantasy multi-player skill-based computer games and matches, (“real” referring to games being played by real life players, and “fantasy” referring to games played by bots).

### BACKGROUND

Multi-player computer games require more than one player to play the game. However, some multi-player games accommodate play by a single player by simulating additional players. This can be done, for example, with customised in-game bots, e.g., a software application that runs an automated script. Bots are sometimes referred to as non-player characters (NPCs), which is a character in a game that is not controlled by a human player.

Bots written for first-person shooter (FPS) games (for example in games like Counter-Strike), usually try to mimic how a human would play a game. Advanced bots may rely on machine learning for dynamic learning of patterns, whereas more trivial bots may rely on lists of behaviours, waypoints, etc. created by the developer.

Where players, or teams of players, play against one another, wagers can be placed on the outcome of the games. Computer systems have been used to support wagering on the outcome of computer implemented games. The best known computer implemented games that allow wagering on game outcomes are casino style games of chance such as slot games. Traditional computer implemented games of chance are completely driven by a random number generator (usually hardware or software based, or a combination of both), which ultimately determines every outcome of the games of chance. In this style of game there is absolutely nothing else other than the random number generator that determines the outcome of the games of chance. No matter what the player selects as an input to the game of chance those selections will not influence the outcome in anyway. One of the major advantages of these traditional games of chance is that operators of these gaming machines (e.g., casino) know exactly how these machines will perform from a revenue perspective (in terms of hold and wins) because the game outcomes will follow a clear statistical model.

In recent years there has been a growing interest in permitting wagering on computer implemented games that incorporate a skill element. That is, the outcome of the games are not entirely determined by a random number generator and can be influenced by a number of external factors, most notability player skill. That is, actions performed by the player can to a degree influence the outcome of the computer implemented game. While allowing a player to exert their skill in a computer implemented game to influence the game outcome has a lot of appeal to players, it can create a level of uncertainty for operators of such gaming machines because the financial performance of these skill-based computer games is not as easy to model because players' skill is generally unknown. This inability to factor in the skill element becomes even more problematic when it comes to computer games that offer very large jackpot prizes because operators of gaming machines like to understand their risk and liability with offering very large jackpot prizes. Having a clear understanding of the risk and liability associated with large jackpot prizes is important since it allows operators to financially manage that risk through means such as financial provisioning, insurance etc.

To address the unknown element associated with player skill, many computer-implemented, skill-based games that allow wagering on their outcomes limit the amount of influence a player can have on the outcome of a game. The outcomes of such games that are skill-based are by and large determined by a random number generator while the players' skill only has a very minor influence on the game outcomes.

While the previously described skill-based computer implemented games enable computer games to offer a newer and more contemporary style of games they are still by and large games of chance. As a result, many of these newer style of skill-based games (that allow wagering) fall well short of the player appeal offered by those computer games that are 100% skill-based, such as games like Counter-Strike, in which the outcome does not have a random input and is all down to player skill.

It is to be understood that any prior art publication referred to herein does not constitute an admission that the publication forms part of the common general knowledge in the art.

### SUMMARY

According to an embodiment, there is provided a computer system for managing a prize that can be awarded based on an outcome of a game, the computer system comprising a data processing arrangement that is arranged to:
access historical game data, wherein the historical game data represents information about historical outcomes of the game;
process the historical game data to generate probability data, wherein the probability data represents information about a plurality of discrete probabilities each of which is associated with a different future outcome of the game; and
process the probability data to generate prize data, wherein the prize data represents at least one characteristic associated with the prize.

The game may be a match played in competition between the plurality of players.

One of the significant advantages of this embodiment of the computer system is that it can facilitate the provision of a computer system that provides a level of certainty around managing and awarding prizes in computer-based games that are predominantly skill-based. More specifically, this advantage is enabled by the fact that the data processing arrangement can process large amounts of actual historical game events (player related events that occur during play of the game) to generate statistical models (the probability data) that can be used to determine the probability associated with different future outcomes of the game. Using these statistical models, the computer system can make changes to prizes based on the calculated statistical models, which might include for example setting the actual value of the prize based on the odds. If the odds of certain events occurring are very likely to occur, then the value of the prize might be reduced or conversely the value of the prize might be increased when the odds of the events occurring are very remote.

In the embodiment of the computer system, the data processing arrangement is such that the step of processing the historical game data comprises:
processing the historical game data to determine frequency distribution data, wherein the frequency distribution data represents information about the occurrence of an event that occurred during the game for a plurality of players; and
processing the frequency distribution data to generate the probability data.

By generating and processing the frequency distribution data the data processing arrangement can efficiently generate the probability data. The frequency distribution data may include adjusted frequency distribution data.

In the embodiment of the computer system, the data processing arrangement is such that it is arranged to:
process the historical game data to determine at least one weighting parameter; and
process the weighting parameter to make a change to any of the discrete probabilities.

An advantage of generating the weighting data is that it can be used to adjust the discrete probabilities based on external factors that may have a positive or negative impact on the probabilities. These external factors might include for example who a player played against or with.

In the embodiment of the computer system the data processing arrangement is arranged to:
process the probability data to determine whether the prize is to be made available to win.

The advantage of processing the probability data to determine whether the prize is available to win is that it takes into account financial risk and liability associated with the odds of awarding the prize. If, for example, the previously described modelling indicated a high likelihood of a prize being won then the prize may not be offered at all.

In the embodiment of the computer system, the computer system comprises a computer networking arrangement arranged to interact with a remote computer server, via a data network, to access the historical game data.

In the embodiment of the computer system, the one characteristic comprises a value of the prize.

In the embodiment of the computer system, the prize is one of a plurality of discrete prizes.

According to another embodiment, there is provided a computer system for managing a prize that can be awarded based on an outcome of a game, the computer system comprising a data processing arrangement that is arranged to:
access wager data that represents information about a future outcome of the game that has been selected for a wager;
access probability data that represents information about a plurality of discrete probabilities each of which is associated with a different future outcome of the game; and
process the wager data and the probability data to determine whether the wager is to be accepted.

In some situations, a wager placed by a person might be too risky for the operator to accept. Accordingly, this embodiment of the system enables filtering of wagers to determine if they are to be accepted based on their risk.

In the embodiment of the computer system, the data processing arrangement is such that it is arranged to:
access historical game data, wherein the historical game data represents information about historical outcomes of the game;
process the historical game data to generate probability data, wherein the probability data represents information about a plurality of discrete probabilities each of which is associated with a different future outcome of the game; and
process the probability data to generate prize data, wherein the prize data represents at least one characteristic associated with the prize.

In the embodiment of the computer system, the data processing arrangement is such that the step of processing the historical game data comprises:
processing the historical game data to determine frequency distribution data, wherein the frequency distribution data represents information about the occurrence of an event that occurred during the game for a plurality of players; and
processing the frequency distribution data to generate the probability data. The frequency distribution data may include adjusted frequency distribution data.

The game may be a match played in competition between the plurality of players.

In the embodiment of the computer system, the data processing arrangement is such that it is arranged to:
process the historical game data to determine at least one weighting parameter; and
process the weighting parameter to make a change to any of the discrete probabilities.

In the embodiment of the computer system, the one characteristic comprises a value of the prize.

In the embodiment of the computer system, the prize is one of a plurality of discrete prizes.

In the embodiment of the computer system, the computer system comprises a local storage device that contains the probability data.

In the embodiment of the computer system, the computer system comprises a computer networking arrangement arranged to interact with a remote computer server system, via a data network, to access the wager data and the historical game data.

According to an embodiment, there is provided a computer system method of managing a prize that can be awarded based on an outcome of a game, the computer system method comprising the steps of:
a data processing arrangement accessing historical game data, wherein the historical game data represents information about historical outcomes of the game;
a data processing arrangement processing the historical game data to generate probability data, wherein the probability data represents information about a plurality of discrete probabilities each of which is associated with a different future outcome of the game; and
a data processing arrangement processing the probability data to generate prize data, wherein the prize data represents at least one characteristic associated with the prize.

The embodiment of the computer system method further comprises:
the data processing arrangement processing the historical game data to determine frequency distribution data, wherein the frequency distribution data represents information about the occurrence of an event that occurred during the game for a plurality of players; and
the data processing arrangement processing the frequency distribution data to generate the probability data. The frequency distribution data may include adjusted frequency distribution data.

The embodiment of the computer system method further comprises:
the data processing arrangement processing the historical game data to determine at least one weighting parameter; and
the data processing arrangement processing the weighting parameter to make a change to any of the discrete probabilities.

In the embodiment of the computer system method, it additionally comprises:
the data processing arrangement processing the probability data to determine whether the prize is to be made available to win.

The embodiment of the computer system method is such that it comprises a computer networking arrangement arranged to interact with a remote computer server, via a data network, to access the historical game data.

The embodiment of the computer system method is such that the one characteristic comprises a value of the prize.

In the embodiment of the computer system method the prize is one of a plurality of discrete prizes.

In an embodiment of a computer system method of managing a prize that can be awarded based on an outcome of a game, the computer system method comprises:
a data processing arrangement accessing wager data that represents information about a future outcome of the game that has been selected for a wager;
a data processing arrangement accessing probability data that represents information about a plurality of discrete probabilities each of which is associated with a different future outcome of the game; and
a data processing arrangement processing the wager data and the probability data to determine whether the wager is to be accepted.

In the embodiment of the computer system method, it further comprises:
the data processing arrangement accessing historical game data, wherein the historical game data represents information about historical outcomes of the game;
the data processing arrangement processing the historical game data to generate probability data, wherein the probability data represents information about a plurality of discrete probabilities each of which is associated with a different future outcome of the game; and
the data processing arrangement processing the probability data to generate prize data, wherein the prize data represents at least one characteristic associated with the prize.

The embodiment of the computer system method is such that it further comprises the steps of:
the data processing arrangement processing the historical game data to determine frequency distribution data, wherein the frequency distribution data represents information about the occurrence of an event that occurred during the game for a plurality of players; and
the data processing arrangement processing the frequency distribution data to generate the probability data. The frequency distribution data may include adjusted frequency distribution data.

The embodiment of the computer system method is such that it further comprises:
the data processing arrangement processing the historical game data to determine at least one weighting parameter; and
the data processing arrangement processing the weighting parameter to make a change to any of the discrete probabilities.

The embodiment of the computer system method is such that the one characteristic comprises a value of the prize.

The embodiment of the computer system method is such that the prize is one of a plurality of discrete prizes.

The embodiment of the computer system method is such that it comprises a local storage device that contains the probability data.

The embodiment of the computer system method is such that it further comprises a computer networking arrangement arranged to interact with a remote computer server system, via a data network, to access the wager data and the historical game data.

According to an embodiment, there is provided a computer-implemented method of generating a fantasy match based on a real competitor, the method comprising: a data processing arrangement accessing historical game data associated with a real competitor; a data processing arrangement processing the received historical game data to calculate probability data; a data processing arrangement accessing a gaming bot having variable play parameters; and a data processing arrangement altering the variable play parameters based on the calculated probability data to create an altered gaming bot, so that behaviour of the altered gaming bot during play of the fantasy match resembles behaviour of the real competitor.

The embodiment of the method may further comprise a data processing arrangement accessing a match environment for the fantasy match; and a data processing arrangement causing the fantasy match to execute with the altered gaming bot in the match environment. Accessing the match environment may comprise creating the match environment.

In the embodiment of the method, accessing the gaming bot may comprise creating the gaming bot.

According to an embodiment, there is provided a computer-implemented method of generating a fantasy match based on a real competitor, the method comprising: a data processing arrangement accessing historical game data associated with a real competitor; a data processing arrangement creating at least one gaming bot having one or more variable play parameters based on probability data associated with the historical game data.

The embodiment of the method may further comprise: a data processing arrangement accessing a match environment for the fantasy match; and a data processing arrangement causing the fantasy match to execute with the at least one gaming bot in the match environment.

In the embodiment of the method, the fantasy match may be executed in an e-sport environment.

### BRIEF DESCRIPTION OF DRAWINGS

Exemplary embodiments of the invention will now be described with reference to the accompanying drawings in which:

FIG. 1 is a schematic diagram of a computer system that facilitates skilled based games and supports electronic wagering on the outcome of the game;

FIG. 2 is a diagram of a wager server used in the system shown in FIG. 1;

FIG. 3 is a flow chart of various steps performed by the wager server illustrated in FIG. 2;

FIG. 4 is another flow chart of various steps performed by the wager server illustrated in FIG. 2;

FIG. 5 is a diagram of a gaming server used in the system shown in FIG. 1;

FIG. 6 is a flow chart of various steps performed by the gaming server illustrated in FIG. 5;

FIG. 7 shows example curves of adjusted probability frequency distributions.

In the drawings, like reference numerals designate similar parts.

### DESCRIPTION

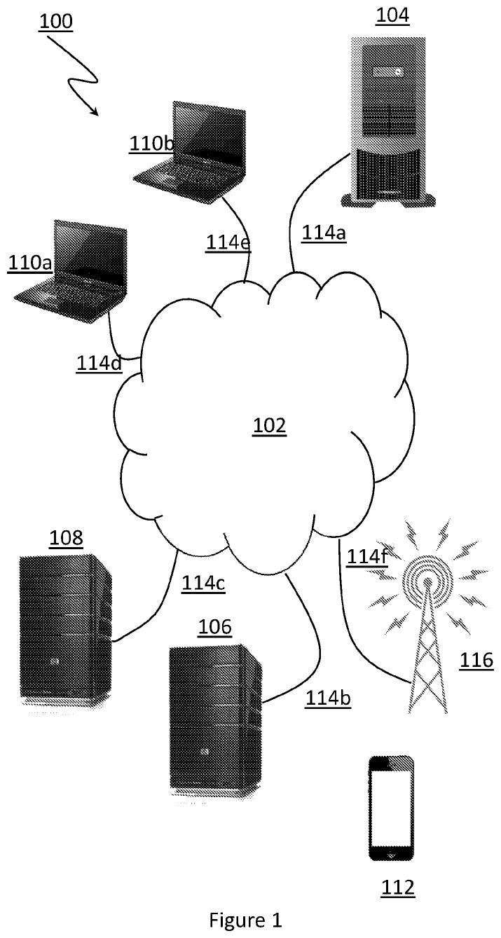

Referring to FIG. 1 this embodiment shows a computer system 100 that enables the play of a skill-based computer game and supports wagering on the outcome of the game. In this particular embodiment of the computer system 100 the skill-based game is the multiplayer first-person shooter (FPS) game, Counter-Strike. Counter-Strike allows groups of players to form teams that can then compete against each other in battle scenarios. While this description of the system 100 is given in the context of the Counter-Strike game it will be apparent to those skilled in the art that the system 100 is not limited to just Counter-Strike and in fact the system can be used to support all contemporary skill-based games that underpin today's e-sports, in particular FPS games and multiplayer games.

As used herein, a “game” refers to a video game or a computer game that is played. A “match” refers to a particular instance of a game that is played as a competition or a contest where one or more players, non-player characters (NPCs), and/or bots compete against one another in playing a game. A “match” also refers to contests for non e-sport applications, for example simulated horse racing.

The system 100 includes a computer network 102, for example in the form of the Internet, which is a packet switch network based on the TCP/IP protocol. The system 100 also has a gaming server 104, which is in the form of an enterprise grade server such as those available from Dell Inc. While this description of the system 100 is provided in the context of the gaming server 104 being a single physical server it is envisaged that in alternative embodiments of the system 100 the gaming server 104 is in the form of a server farm in which various computational tasks are distributed across the server farm. As persons skilled in the art will appreciate a server farm assists in managing high load environments, which is common in large high performance multiplayer gaming environments.

The system 100 also includes a wager server 106 which, similar to the gaming server 104, is in the form of a physical enterprise grade server available from companies such as Dell Inc. As described in more detail in the following sections of this specification the wager server 106 is responsible for allowing people to place electronic wagers on the outcome of the computer games that are run on the gaming server 104. The wagering server 104 also has a function in relation to managing the award of monetary prizes based on outcomes of the computer game running on the gaming server 104.

The system 100 also includes a bookmaker server 108 which is also in the form of an enterprise grade server 108 available from a company such as Dell Inc. As described in more detail in the subsequent sections of this specification the bookmaker server 108 provides a user front end for allowing people to place electronic wagers on the outcomes of the computer games that run on the gaming server 104. The bookmaker server 108 communicates with the wager server 106 to provide wagering on outcomes of computer games operating on the gaming server 104.

The system 100 comprises various player computing devices 110. In this embodiment of the system 100 the player computing devices 110 are consumer devices in the form of personal computers and/or gaming consoles available from companies such as Dell Inc (personal computers) and Sony (gaming consoles). These computer devices 110 allow people to engage and play the computer game that runs on the gaming server 104. It is noted that FIG. 1 shows two player computing devices 110a and 110b and this is done for the sake of clarity. In reality the system 100 could include tens, thousands, tens of thousands or more of the player computing device 110.

Lastly, the system 100 also comprises a wagering device 112 which is in the form of a portable personal computing device such as a smart phone. As described in more detail in the following sections of this specification the wagering device 112 allows a person to place an electronic wager on outcomes of the computer game running on the gaming server 104 when a match is played. FIG. 1 shows only one wagering device 112 for the sake of clarity but, in reality, the system 100 could include tens, thousands, tens of thousands or more of the wagering devices 112.

All of the previously mentioned computing devices 104 to 112 interact with each other and this interaction is facilitated by the computer network 102. More specifically, the gaming server 104, wager server 106, bookmaker server 108 and player computing devices 110 are all connected to the computer network 102 via high speed data links 114. These data links 114 allow the gaming server 104, wager server 106, bookmaker server 108 and player computing devices 110 to exchange data with each other. In relation to the wagering device 112, this device 112 may also be a computing device connected to the computer network 102 via a high speed data link 114. In the illustrated exemplary embodiment, this device 112 is a wireless portable computing device in the form of a smartphone so the device 112 forms part of a cellular mobile phone system 116 operated by a telecommunications company such as Sprint. The wagering device 112 is in data communication with the cellular system 116 via a wireless link. In turn, the cellular system 116 is connected to the computer network 102 via a high speed data link 114f, which allows the wagering device 112 and the other computing devices 104 to 110 in the system 100 to exchange data with each other.

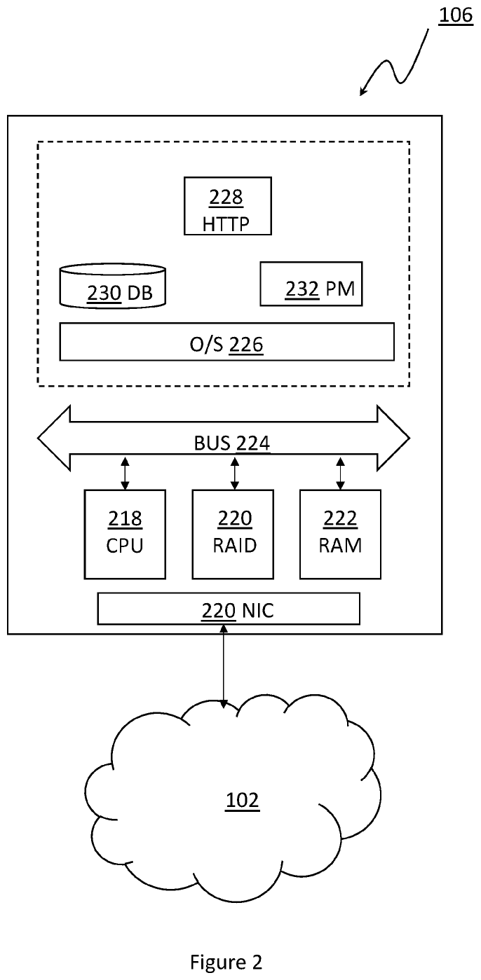

One of the functions provided by the system 100 is to enable people to place electronic wagers on the outcomes of matches in skill-based computer games that are operating on the gaming server 104. In this regard, the functions and operations are provided by the wager server 106 and as such the following description of the system 100 focuses on the wager server 106. As mentioned previously, the wager server 106 is in the form of an enterprise grade server such as those made available by Dell Inc. FIG. 2 provides a diagram of some key components of the wager server 106. Referring to FIG. 2, the wager server 106 comprises a data processing arrangement that comprises a number of components including a central processing unit (CPU) 218, a data storage device 220 which is in the form of a Redundant Array of Inexpensive Disks (RAID), and random access memory (RAM) 222. These three components 218, 220 and 222 cooperate with each other by exchanging data over a bus 224. To enable the wager server 106 to exchange data via the computer network 102 the wager server 106 also comprises a network interface controller (NIC) 220.

The wager server 106 comprises many pieces of software including an operating system (O/S) 226. In this embodiment of the wager server 106 the operating system 226 is in the form of the Microsoft Windows server software. The operating system 226 resides on the RAID 220 and is executed during boot up of the server 106. The operating system 226 provides a level of control over the various hardware (e.g., the CPU 218, RAID 220, RAM 222 and the NIC 220) in the wager server 106. The operating system 226 also provides an environment for application software to be executed in the wager server 106. The wager server 106 executes several pieces of application software. Like the operating system 226, the application software resides on the RAID 220, and is loaded and executed shortly after the operating system 226 is fully loaded and operational.

Included in the application software executed on the wager server 106 is a web server 228 that can manage Hypertext Transfer Protocol (HTTP) requests. As described in more detail in following sections of this specification the web server 228 is designed to allow operators of the bookmaker server 108 to interact with the wager server 106. In this particular embodiment of the wager server 106 the web server software 228 is the web server that is part of the Microsoft Windows server operating system 226.

Another piece of application software that the wager server 106 also comprises is database 230 (DB) software, which is used to store historical game outcomes of the computer game that is run on the gaming server 104.

An important piece of application software that the wager server 106 contains is prize management software (PM) 232. A detailed description of the prize management software (PM) 232 is provided in the following sections of this specification but, in short, the PM application software 232 carries out functions that are used to set a range of characteristics associated with prizes that can be won by placing wagers on the outcomes of the computer games that are controlled by the gaming server 104.

Allowing people to wager on outcomes of games of pure chance (e.g., slot games) is a relatively straightforward issue because the statistical properties of the game can be modelled which means the probabilities of prizes being awarded can be accurately calculated. This means that the operators of such games of chance (e.g., casino) can with great accuracy model and understand the financial liabilities and risks associated with running these games of chance. However, for computer games that have outcomes that are based entirely, or at least in part, on the skills of those people playing the games, existing technology, processes and methodology for modelling and managing the financial risk for potential prizes do not work. It is this scenario that the prize management software 232 enables—it allows the liability and risk associated with offering prizes to be managed in relation to the skilled based games (e.g., Counter-Strike) that are run on the gaming server 104.

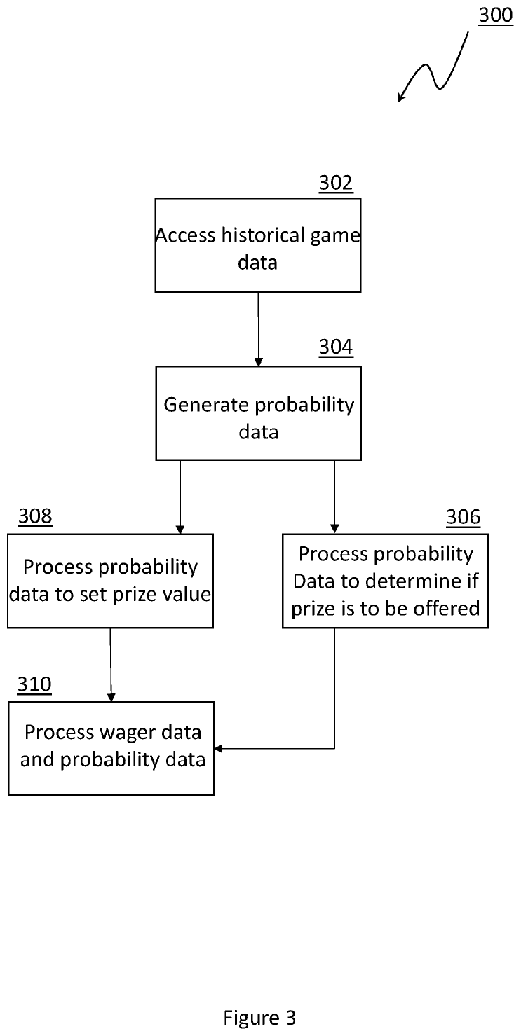

Referring to FIG. 3, the flow chart 300 includes various steps performed by the wager server 106. It is noted that these steps 300 are initiated and/or controlled by the prize management software 232 in conjunction with the previously described software and hardware elements of the wager server 106.

The first step 302 that the wager server 106 performs is to access historical game data. The historical game data contains a range of information about specific players of the computer game (which in this embodiment is Counter-Strike) that is run on the gaming server 104. The information about the players is historical game related data and includes (but is not limited to) details from previous matches played such as the kill count (also referred to as kill rate, i.e., the number of kills a player gets for each specific game); average damage per round; reaction time; how many games the player has played; positions held; utility usage (i.e., use of available features that affect performance); details of specific teams that the player has played with; and a rating of the player for the computer game. In summary the historical game related data can be any historical performance data related to players' performance in the computer game.

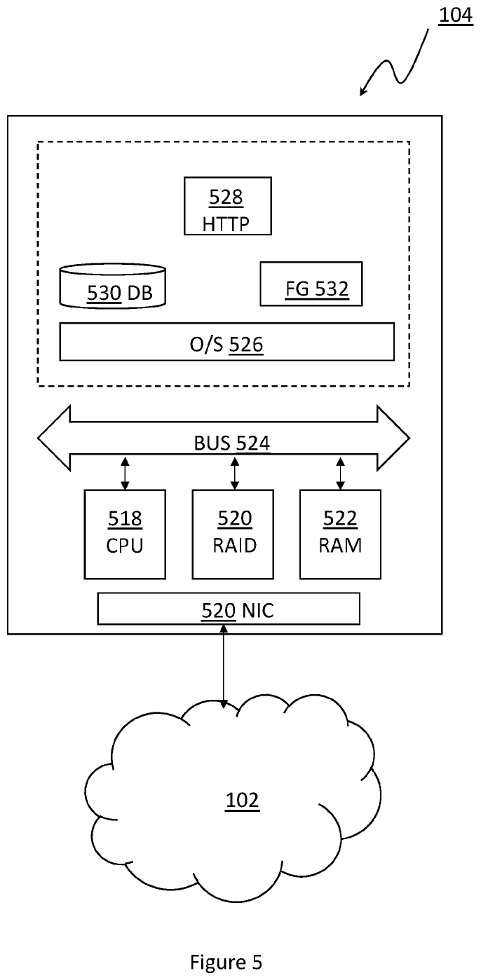

During the first step 302 the wager server 106 sends a data request message to the gaming server 104, which is transferred via the computer network 102 from the wager server 106 to the gaming server 104. On receiving the data request message, the gaming server 104 transfers the historical game data to the wager server 106 via the computer network 102. The gaming server 104 is such that in addition to executing and controlling the computer game it is also arranged to log and record player statistics which are used by the gaming server 104 to create the historical game data. As described elsewhere herein with respect to FIG. 5, the gaming sever 104 has a similar structure to that of the wager server 106 as shown in FIG. 2 so the gaming server 104 will store and maintain the historical game data in its RAID 520.

Once the wager server 106 has performed the initial step 302 of accessing the historical game data the next step 304 that the wager server 106 performs is to process the historical game data to generate probability data. In summary the probability data represents information about a plurality of discrete probabilities each of which is associated with a different future outcome of the computer game running on the gaming server 104. As discussed in more detail in the following sections of the specification the wager server 106 is used to facilitate wagering on outcomes of the computer game running on the gaming server 104 so the step 304 of generating the probability data is used in assessing the risk and financial liability of wagering on future outcomes of the game.

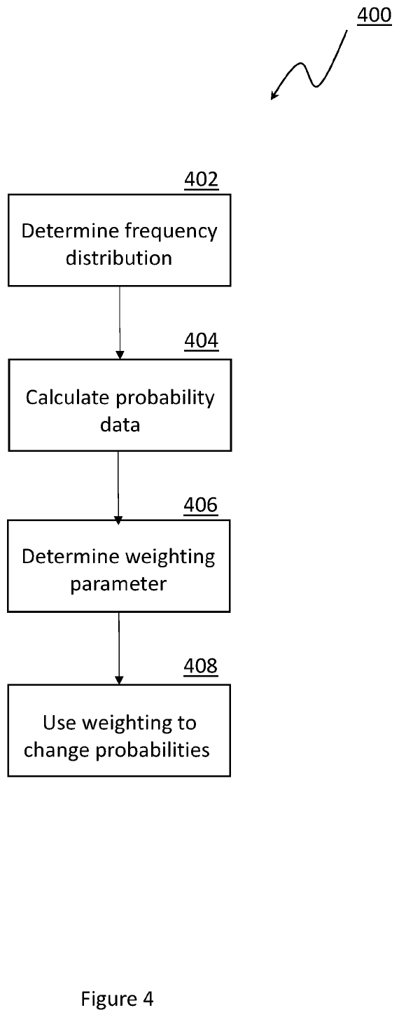

More specifically, the step 304 of processing the historical game data to generate the probability data involves several sub-steps which are performed by the wager server 106. Referring to FIG. 4 which provides a flow chart 400 of the sub-steps, the first sub-step 402 involves the wager server 106 processing the historical game data (obtained during an earlier step 302) to determine frequency distribution data. In summary the frequency distribution data represents information about the actual occurrence of one or more events that have occurred during play of the game on the gaming server 106. To put this into context, the historical data (obtained during the preceding step 302) includes, among other things, the kill rate for each player of the game (for example, for Counter-Strike). The kill rate is the number of enemy kills that each player of the game has obtained for each of their historical plays of the game. As such, in the case of the first sub-step 402, the frequency distribution that is calculated is the distribution of kills each player has obtained per game. The following provides a simplistic example of the frequency distribution of kills per game in relation to historical kills obtained during play of the games by players.

| | 0-4 | 5-9 | 10-14 | 15-19 | 20-24 | 25+ |
|---|---|---|---|---|---|---|
| PLAYER | kills | kills | kills | kills | kills | kills |
| PLAYER A | 5 | 10 | 4 | 15 | 12 | 1 |
| PLAYER B | 0 | 5 | 11 | 5 | 8 | 3 |
| PLAYER C | 1 | 14 | 3 | 18 | 2 | 0 |
| PLAYER D | 6 | 8 | 21 | 2 | 0 | 0 |

The above frequency distribution shows the kill rate frequency distribution for four players (PLAYER A, PLAYER B, PLAYER C and PLAYER D). In relation to player A, the above table shows that for 5 games PLAYER A achieved between 0-4 kills, for 10 games they got 5-9 kills, for 4 games the player achieved 10-14 kills, for 15 games the player achieved 15-19 kills, for 12 games the player achieved 20-24 kills and for 1 game they achieved 25 plus kills. The above frequency distribution is a simplistic example for the sake of clarity, but, in reality, a game such as Counter-Strike has hundreds of thousands of players who play a lot of games so the frequency distribution of kills would include a great deal of data.

Once the wager server 106 has performed the step 402 of obtaining the frequency distribution the wager server 106 proceeds to perform the next step 404 of further processing the frequency distribution to generate the probability data, which represents the possible probabilities of future outcomes of the computer game running on the gaming server 104. The following table shows the probability data that is generated during this step 404 using the above frequency distribution table. Again, this is a simplistic example for the sake of clarity of this description.

| | 0-4 | 5-9 | 10-14 | 15-19 | 20-24 | 25+ |
|---|---|---|---|---|---|---|
| PLAYER | kills | kills | kills | kills | kills | kills |
| PLAYER A | 0.106 | 0.213 | 0.085 | 0.319 | 0.255 | 0.021 |
| PLAYER B | 0 | 0.156 | 0.344 | 0.156 | 0.25 | 0.093 |
| PLAYER C | 0.026 | 0.368 | 0.079 | 0.473 | 0.053 | 0 |
| PLAYER D | 0.162 | 0.216 | 0.567 | 0.054 | 0 | 0 |
| OUTCOME | 0 | 0.0026 | 0.0013 | 0.0013 | 0 | 0 |
| PROB. | | | | | | |

The above table represents the probability for each player getting a number of kills. For example, PLAYER A has a probability of 0.106 (or 10.6%) of getting 0-4 kills, 0.213 (or 21.3%) of getting 5-9 kills and so on. These probabilities are calculated by the following formula: number of games per kill bin/total games. In the case of PLAYER A they played 5 games of a total of 47 games in which they achieved 0-4 kills, giving a 5/47=0.106 or 10.6% chance of getting 0-4 kills.

The probabilities shown in the table represent an unadjusted frequency distribution. In some cases, for example where relatively few games have been played, it is possible that the unadjusted frequency distribution represents an unrealistic distribution (for example if a player has only played 4 games, and achieved 10 kills in each, then the distribution will be a spike at 10 kills, with zero probability elsewhere). In some embodiments, the frequency distribution per player is adjusted using a statistical method such as a smoothing method (for example by implementing local regression, additive smoothing, a filtering technique, a moving average, etc.).

Another statistic method of adjusting the frequency distribution is to extrapolate the frequency distribution to extend across the number of kills possible in the game. For example, referring to the outcome probability table above, one way of representing the data is as shown: with six categories or “bins”. This type of histogram representation is an accurate representation for the unadjusted frequency distribution. In some embodiments, the frequency distribution is adjusted to extrapolate so that the adjusted frequency distribution is calculated for all possible scores (i.e., the “tail end” of the curve is estimated). This may be performed with a one or more extrapolation methods to extend the adjusted frequency distribution beyond the known data, for example linear, polynomial, or conic extrapolation.

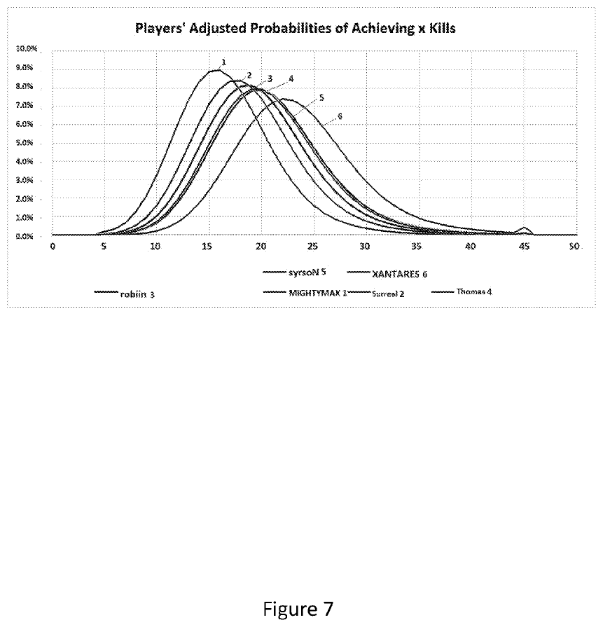

FIG. 7 illustrates adjusted probabilities for multiple players: the curves are smoothed and extrapolated, with the maximum number of possible kills on the X axis being 50, and the probability on the Y axis.

Throughout this document, where probability data or frequency distribution is referenced, this may include an unadjusted and/or an adjusted statistic.

Notable in the above probability table is the row “OUTCOME PROB.”. This probability data is the overall probability that all players will achieve a given number of kills. For example, the probability that all players will achieve 5-9 kills is 0.0026 or 0.26% similarly the probability that all players get 15-19 kills is 0.0013 or 0.13%. As described in the following sections of this specification this overall probability, OUTCOME PROB., is used in the risk and financial analysis and in determining whether wagers are accepted and what the monetary size of the prize will be.

Because of the nature of typical computer games (such as Counter-Strike) that run on the gaming server 104 it is likely that the particular performance (e.g., number of kills a player achieves) of a player in the game can be influenced by factors other than the inherent skill of a player. For example, in a team based computer game such as Counter-Strike a player forms part of a team of players and their level of skill (or lack of skill) may well have a direct influence on (or be influenced by) one or more of the other players' performance characteristics such as kill rate or utility usage (as in the case of Counter-Strike). It is envisaged that depending on the computer game there may be a range of different external factors (e.g., the size of the team, team member reaction times, etc.) that will influence the players' results (e.g., kill rate or average damage per round). What this means is that the probabilities in the above table may not be entirely accurate and account for the external influencing factors.

To account for external factors the wager server 106 is such that it performs an additional step 406 of processing the historical game data to extract any information about external factors that may have an impact on a player's performance. This information is represented as weightings that can be applied as follows. The information about external factors might, for example, include data on which players a particular player has played with (team members), how many games a particular player has played in total, etc. For instance, according to the above table it shows that PLAYER B has a probability of 0.093 (or 9.3%) chance of obtaining 25 or more kills in a game. However, if the wager server's 106 processing of the historical game data reveals all of these games were against low ranked and poor performing teams then that 0.093 probably could be weighted accordingly such that its overall contribution to the related OUTCOME PROB. is reduced. Conversely, if this 25 or more kill rate was against the best performing teams then a weighting may be applied that increases the overall contribution to OUTCOME PROB.

Once the wager server 106 has extracted this detail from the historical game data and determined the weighting parameter, then the wager server 106 can perform the next step 408 of applying the appropriate weightings to the above probabilities to account for external influences. The end result of this step 408 is that the initial probabilities shown in the above table may be adjusted depending on the weightings that the wager server 106 has calculated.

At this point, once the wager server 106 has obtained the probability data as outlined above, the wager server 106 can use this probability data in relation to a prize which could include a monetary prize. One of the functions of the wager server 106 is that it facilitates wagering on the outcomes of the game (Counter-Strike) running on the wager server 106. This is described in more detail in the following sections of this specification, but the wagers involve allowing a user of the wagering device 112 to pick the outcome of a game. More specifically and in relation to the data tables above, a user of the wagering device can place a wager that the outcome of an upcoming Counter-Strike game is that PLAYER A will get 0-4 kills, PLAYER B will get 15-19 kills, PLAYER C will get 5-9 kills and PLAYER D will get 20-24 kills. Basically, the user can select and wager on whatever combination of kills PLAYERS A to D will get in a particular game or for a series of games.

In some embodiments, before accepting wagers from a user of the wagering device 112, the wager server 106 carries out a function related to managing the risk and liability associated with accepting wagers. Referring to FIG. 3, the wager server 106 performs the step 306 of processing the OUTCOME PROB. data (illustrated in the above table) to determine whether any of those probabilities are too high. For example, if the prize to be awarded for picking the outcome of the game was $1,000,000 and one of the OUTCOME PROB. indicated, for example, a probability of 0.8 (or 80% chance) then the wager server 106 could be configured to not offer any prize in this case since the odds of it being awarded are too great. The wager server 106 is arranged such that an operator of the server 106 can enter a maximum probability it is willing to accept for the prize to be awarded. This entered probability is then used by the wager server 106 as the threshold when it is performing the step 306 of processing the OUTCOME PROB.

Step 306 is essentially a step undertaken to determine whether or not a prize is to be offered. Additionally or alternatively, the wager server 106 can perform the step 308 of processing the OUTCOME PROB. and then using the relevant probability to adjust the prize to an acceptable level. As such, in the prior example of a 0.8 probability of a particular outcome occurring, the wager server 106 could reduce the prize from $1,000,000 to say $100. Conversely if the probability is extremely low then the wager server 106 could increase the prize from $1,000,000 to say $5,000,000. This is about managing the risk and financial liability associated with offering a prize based on wagers placed on outcomes of the game. The method described by flow chart 300 can include step 306 and/or step 308 to generate prize data that represents at least one characteristic associated with the prize. This characteristic associated with the prize may be, for example, whether or not there is a prize that will be awarded at all, it may be an indication of whether the prize will be increased or decreased, or it may be the value of the prize.

As outlined previously, a user of the wagering device 112 can (using the device 112) place wagers on the outcome of the computer game running on the gaming server 104. To facilitate this the wagering device 112 has an appropriate application that allows the user to enter details of the desired outcome on which they wish to wager. In the exemplary embodiment where the computer game running on the gaming server 104 is Counter-Strike, the user of the wagering device 112 is allowed to pick an outcome that corresponds to the number of kills one or more of the team players will achieve in an upcoming game. In the case of the simple example given earlier, this would involve the application on the wagering device allowing the user to enter the number of kills PLAYER's A to D will achieve. For example, the user of the wagering device 112 might wager on the following outcome: PLAYER A 0-4 Kills, PLAYER B 10-14 Kills, PLAYER C 5-9 Kills, and PLAYER D 25+ kills. Once the user of the wagering device 112 has entered their wager (game outcome) the application submits wager data to the bookmaker server 108 by sending it via the networks 116 and 102.

In this particular embodiment of the system 100 the bookmaker server 108 provides the user (punter) front end; that is, it is the server 108 that interoperates directly with the wagering device 112. The wager server 106 manages prizes and processes wagers, but in this exemplary embodiment it does not provide a user front end to the wagering device 112. The bookmaker server 108 interacts with the wager server 106 to obtain details of prizes that can be won by wagering on outcomes of the games operating on the gaming server 104. The bookmaker server 108 promotes and advertises prizes to users of the wagering device 112. The bookmaker server 108 also receives the wager data (mentioned in the above paragraph) and passes that wager data on to the wager server 106 for processing. In other embodiments, the functionality of the bookmaker server 108 and the wager server 106 may be combined or collocated within one server, they may be combined with the gaming server, or alternatively the bookmaker server 108 and the wager server 106 may be distributed amongst more than the two servers as described.

On receiving the wager data from the bookmaker server 108, the wager server 106 carries out the step 310 of processing the probability data (OUTCOME PROB.) and the wager data to make a wager determination. In some embodiments, the wager determination includes whether the outcome selected by the user of the wagering device 112 is accepted or not. If the wager server 106 does not accept the wager, then the wager determination includes that the user of the wagering device 112 is not eligible to win the prize.

In this description of the embodiment of the system 100 it is envisaged that the operators of the gaming server 104, wager server 106 and bookmaker server 108 are independent and separate operators, however in some applications of the system 100 it is envisaged that an operator may own and operate more than one of the servers. For example, the same operator may own and operate the bookmaker server 108 and the wager server 106.

It is also noted that in this description of the system 100, the gaming server 104 creates and generates the historical game data. It is envisaged that in an alternative embodiment of the system 100 the historical game data is provided and/or supplemented by a server that is separate and independent to the gaming server 104.

Although this embodiment of the system 100 is described in the context of allowing wagering of outcomes of computer implemented games, the system 100 can be easily applied to support wagering on real sports such as, for example, professional football and tennis. In this scenario the historical game data would represent historical events achieved by particular sportspeople.

While not explicitly described in the description of the system 100, the system 100 can be used to support “in play” betting. That is wagers can be accepted before and during (in play) the play of the computer implemented game.

Even though in this description the computer game operating on the gaming server 104 is a game of skill it is acknowledged that such games may also have an element of randomness, but this element of randomness may, for some games, be largely insignificant compared to the influence that the level of player skill, or unique player characteristics, have on the outcome of games.

In a further embodiment, the computer system and methods for managing a prize that can be awarded based on an outcome of a game as described above, are applicable to a game that includes software-based players, e.g., bots. Such games can be played by a combination of real players and bots, or by bots alone.

Customised in-game AI players are pre-programmed with decision making capabilities based on behaviour trees. This allows each individual bot to take in-game information (like sounds and sightings of the enemy in an FPS game) and process the information in order to determine actions in response based on the logic code for that bot. Behaviour trees used to create bots are implemented in a manner known in the art, and using parameters that define the behaviour of each bot.

Fantasy matches, e.g., matches played by bots, can be adapted to mimic the real play of real players in real matches. Where historical game data is available for real players, described herein is a novel method that uses that data to create bots that simulate those particular players. Similarly, particular teams of players can be simulated using historical game data that describe the team play. Accordingly, the parameters that define the behaviour of each bot is adapted based on the historical game data associated with the particular player and within a specified context (e.g., the player being part of a certain team, playing a particular game or game level, playing a match against certain opponents, etc.) that the bot represents.

Counter-Strike bots have play parameters that include fixed parameters and variable parameters. Fixed parameters are independent of a particular player to be simulated and are typically set with a fixed value for bots of a certain type irrespective of the player (for example defining a field of vision, boundaries of movement, etc.). Variable parameters vary depending on the player being represented. Variable parameters may include, but are not limited to, kill rate, average damage per round, reaction time, and utility usage. For example, Player One may have an average reaction time of 0.12 s and Player Two may have an average reaction time of 0.17 s; the respective variable “average reaction time” parameter for each player's representative bot would then be set accordingly.

FIG. 5 provides a diagram of various components of an exemplary embodiment of the gaming server 104. Referring to FIG. 5, the gaming server 104 comprises a data processing arrangement that comprises a number of components including a central processing unit (CPU) 518, a data storage device 520 which is in the form of a Redundant Array of Inexpensive Disks (RAID), and random access memory (RAM) 522. These three components 518, 520 and 522 cooperate with each other by exchanging data over a bus 524. To enable the gaming server 104 to exchange data via the computer network 102 the gaming server 104 also comprises a network interface controller (NIC) 520.

The gaming server 104 comprises software including an operating system (O/S) 526. In this embodiment of the gaming server 104 the operating system 526 is in the form of the Microsoft Windows server software. The operating system 526 resides on the RAID 520 and is executed during boot up of the server 104. The operating system 526 provides a level of control over the various hardware (e.g., the CPU 518, RAID 520, RAM 522 and the NIC 520) in the gaming server 104. The operating system 526 also provides an environment for application software to be executed in the gaming server 104. The gaming server 104 executes several pieces of application software. Like the operating system 526, the application software resides on the RAID 520, and is loaded and executed shortly after the operating system 526 is fully loaded and operational.

Included in the application software executed on the gaming server 104 is a web server 528 that can manage Hypertext Transfer Protocol (HTTP) requests. The web server 528 supports interaction with other components of the system 100. In this embodiment the web server software 528 is the web server that is part of the Microsoft Windows server operating system 526.

Another piece of application software that the gaming server 104 also comprises is database 530 (DB) software, which is used to store historical game outcomes of the computer game that is run on the gaming server 104.

The gaming server 104 also has fantasy match (FM) software 532. The FM software 532 runs fantasy matches played by bots that are created by the FM software 532. The bots are created to mimic the behaviour of one or more real competitors based on historical game data that describes games and/or matches played by the real competitors.

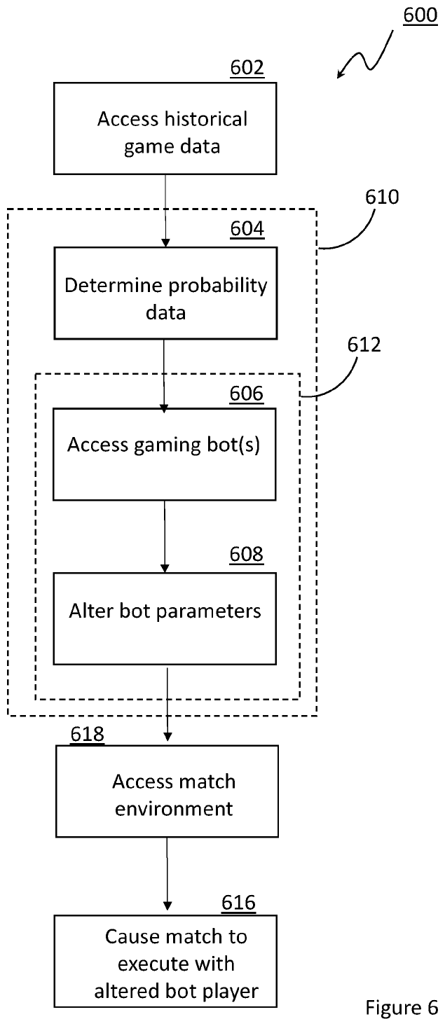

Referring to FIG. 6, flow chart 600 shows various steps performed by the gaming server 104 that form part of the creation of a fantasy match based on one or more real competitors. At step 602 the data processing arrangement of the gaming server 104 accesses the historical game data relevant to the fantasy match. The historical game data may, for example, be retrieved from the RAID 520. In other embodiments, the historical game data may, for example, be accessed via cloud storage.

The historical game data contains a range of information about specific players of the computer game (which in this embodiment is Counter-Strike) that is run on the gaming server 104. The information about the players is historical game related data and includes (but is not limited to) details from previously played games and/or matches such as the kill count (also referred to as kill rate, i.e., the number of kills a player gets for each specific game); average damage per round; reaction time; how many games the player has played; positions held; utility usage (i.e., use of available features that affect performance); details of specific teams that the player has played with; and a rating of the player for the computer game. In summary the historical game related data includes any data descriptive of a player's behaviour, including historical performance data related to players' performance in the computer game, data relating to unique characteristics of a particular player, such as choice or decision preferences (for example, weapon selection under certain game conditions), a player's behaviour when teamed or in contest with particular other players, etc.

At step 604 the data processing arrangement of the gaming server 104 determines probability data from the historical game data. In one example (as described above with reference to the operation of the wagering server 106) the frequency distribution of kills per game in relation to historical kills obtained during play of the games by players, is determined. The frequency distribution is then used to calculate probability data, including an overall probability that all players will achieve a given number of kills.

In a similar way, the frequency distribution of other parameters can be determined, for example relating to average damage per round, average reaction time per round or per game, utility usage per game (or per round or per kill rate), etc. The frequency distribution is then used to calculate probability data, for example in a manner similar to that described above with reference to the kill count probability data as calculated by the wager server 106.

In some embodiments, the probability data determined in step 604 may be conditional probability data. For example, a real competitor may behave in one way when playing a match as a member of a first team, and may behave in another way when playing as a member of a second team. This may be, for example, a function of the ability and behaviours of other team members in the respective teams. By applying conditional probability data, fantasy match bots may be collectively coded to access strategies frequently seen used by certain teams. For example, different attack strategies or defensive strategies that are frequently seen employed by a certain team may be accessible (or given a higher weighting) than other strategies. Conversely, those strategies not seen used by a certain team would be inaccessible by that team, or may be given a lower weighting.

At step 606 the data processing arrangement of the gaming server 104 accesses one or more gaming bots for a fantasy game, the gaming bots each configured to form part of the fantasy game in a manner determined by play parameters, such as skill ceilings (with respect to game actions, e.g., hit rate, speed, etc.). The bots are created using methods known in the art, for example using behaviour trees. In some embodiments, the step of accessing the bot(s) may include creating the bot(s).

At step 608 the play parameters of a bot that represents a real competitor are altered based on the historical game data (e.g., an average response time associated with the real competitor may be applied), and/or based on the calculated probability data (e.g., an expected average and/or maximum kill count may be applied). In this way, the behaviour of the gaming bot during play of the fantasy match will then resemble the behaviour of the real competitor.

For example, historical game data may indicate that Player One is a rifle player and therefore will have a lower weighting towards buying certain weapons, such as the in-game sniper rifles. While the Player One bot may still buy a sniper rifle (to account for real-world whimsy), there would be a lower chance of this occurring as this would be out of character for the real-world player. On the other hand, Player Two may be the primary sniper on a team and will therefore have a higher weighting towards buying a sniper rifle. As a result, the Player Two bot will treat their personal economy (i.e., in-game spending habits) differently to the Player One bot in order to ensure they can buy the more expensive sniper rifles. Accordingly, in this example, variable parameters that relate to weapon selection and spending preferences are altered for the Player One bot and the Player Two bot based on the historical data identifying their typical preferences for rifle or sniper play.

In some embodiments, the calculated probability data may be multi-dimensional, representing not only a probability of occurrence, but also a related probability of effect or outcome. For example, historical data may show that Player One's utility usage (i.e., the frequency in which they use in-game utility items such as smoke or flash grenades) is not as high as utility usage for Player Two. In addition to measuring utility usage in game, other related performance metrics (such as the number of ‘effective flashes’ by a player, i.e., the use of a flash grenade that impacts a target) may be measured as well. The related performance metric can then be used to weight the utility usage effectiveness (being an indicator of the player's skill), similar to how the frequency of utility usage is used to weight the relevant utility usage parameter. The Player One bot might therefore have a lower weighting towards utility usage and/or “advanced utility usage” (being more effective use), whereas the Player Two bot might have a higher weighting in both utility usage and advanced utility usage categories and therefore have access to a wider array of utility strategies and therefore be more likely to use utility in general.

In some embodiments, steps 606 and 608 are not separate or consecutive steps, but instead the gaming bots are created at a combined step 612 using play parameters that are based on the historical data and/or the determined probability data.

In some embodiments, for example, applying the probability data to set or alter bot parameters may be done by setting learning rules (e.g., mathematical logic) for a neural network that is used to create the bots, in a manner known in the art. For example, one or more of a Hebbian, Perceptron, Delta, Correlation, and Outstar learning rule may be applied to the neural network to improve the neural network's performance by updating the weights and bias levels of the network when it simulates in the specific data environment where historical game data is applied to the creation of bots for a particular game.

In other embodiments, steps 604, 606, and 608 are not distinct or consecutive steps. For example, where machine learning is used to train a fantasy game bot on historical data (for example using neural networks or other artificial intelligence as is known in the art), the creation of the gaming bot at step 610 incorporates probability characteristics inherent in the historical data by virtue of the machine learning process. In these embodiments, the variable parameters of each bot are determined as part of the bot creation process whereby the probability-dependent weightings are determined by the machine learning process.

In some embodiments, the wagering server 106 facilitates wagering on the outcomes of a fantasy match based on real competitors, as described above with reference to FIG. 6. The wager server 106 may carry out a function related to managing the risk and liability associated with accepting the wagers as described above with reference to FIG. 3, and taking into consideration the same historical game data and calculated probability data as is used in setting and/or altering the play parameters of the bots used in the fantasy match.

The method of creating or altering bots based on historical game data can also be applied to non e-sports. For example, a fantasy horse race may be set up with horses representative of real horses. Parameters that relate to the behaviour or performance of a particular horse are determined based on historical race data, and these are applied to a simulated horse race.

At step 618 a “match environment” is accessed. In some embodiments, the match environment is an existing game such as Counter-Strike, which provides the environment in which the developed bots are applied to play a fantasy game. In other embodiments, accessing the match environment may include creating the match environment. In the abovementioned horse racing example for instance, a race track and competing horses may be generated as the match environment in which to execute a fantasy horse race.

At step 616, the altered bots are applied to the match environment, and the processor will cause the match to execute within the match environment and using the bots as altered based on historical game data.

Described herein is a computer-implemented method outlined in the following clauses:

Clause 26. A computer-implemented method of managing a prize that can be awarded based on an outcome of a game, the computer-implemented method comprising the steps of:
a data processing arrangement accessing wager data that represents information about a future outcome of the game that has been selected for a wager;
a data processing arrangement accessing probability data that represents information about a plurality of discrete probabilities each of which is associated with a different future outcome of the game; and
a data processing arrangement processing the wager data and the probability data to determine whether the wager is to be accepted.

Clause 27. The computer-implemented method according to clause 26, further comprising the steps of:
the data processing arrangement accessing historical game data, wherein the historical game data represents information about historical outcomes of the game;
the data processing arrangement processing the historical game data to generate probability data, wherein the probability data represents information about a plurality of discrete probabilities each of which is associated with a different future outcome of the game; and
the data processing arrangement processing the probability data to generate prize data, wherein the prize data represents at least one characteristic associated with the prize.

Clause 28. The computer-implemented method according to clause 26 or 27, further comprising the steps of:
the data processing arrangement processing the historical game data to determine frequency distribution data, wherein the frequency distribution data represents information about the occurrence of an event that occurred during the game for a plurality of players; and
the data processing arrangement processing the frequency distribution data to generate the probability data.

Clause 29. The computer-implemented method according to clause 27 or 28, further comprising the steps of:
the data processing arrangement processing the historical game data to determine at least one weighting parameter; and
the data processing arrangement processing the weighting parameter to make a change to any of the discrete probabilities.

Clause 30. The computer-implemented method according to any one of clauses 26 to 29, wherein the one characteristic comprises a value of the prize.

Clause 31. The computer-implemented method according to any one of clauses 26 to 30, wherein the prize is one of a plurality of discrete prizes.

Clause 32. The computer-implemented method according to any one of clauses 26 to 31, comprising a local storage device that contains the probability data.

Clause 33. The computer-implemented method according to any one of clauses 26 to 32 further comprising a computer networking arrangement arranged to interact with a remote computer server system, via a data network, to access the wager data and the historical game data.

Clause 34. A computer-implemented method of generating a fantasy match based on a real competitor, the method comprising:
a data processing arrangement accessing historical game data associated with a real competitor;
a data processing arrangement processing the received historical game data to calculate probability data;
a data processing arrangement accessing a gaming bot having variable play parameters; and
a data processing arrangement altering the variable play parameters based on the calculated probability data to create an altered gaming bot, so that behaviour of the altered gaming bot during play of the fantasy match resembles behaviour of the real competitor.

Clause 35. The computer-implemented method according to clause 34, further comprising:
a data processing arrangement accessing a match environment for the fantasy match; and
a data processing arrangement causing the fantasy match to execute with the altered gaming bot in the match environment.

Clause 36. The computer-implemented method according to clause 35, wherein accessing the match environment comprises creating the match environment.

Clause 37. The computer-implemented method according to any one of clauses 34 to 36, wherein accessing the gaming bot comprises creating the gaming bot.

Clause 38. A computer-implemented method of generating a fantasy match based on a real competitor, the method comprising:
a data processing arrangement accessing historical game data associated with a real competitor;
a data processing arrangement creating at least one gaming bot having one or more variable play parameters based on probability data associated with the historical game data.

Clause 39. The computer-implemented method according to clause 38, further comprising:
a data processing arrangement accessing a match environment for the fantasy match; and
a data processing arrangement causing the fantasy match to execute with the at least one gaming bot in the match environment.

Clause 40. The computer-implemented method according to clause 38 or 39, wherein the fantasy match is executed in an e-sport environment.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-25. (canceled)

26. A computer-implemented method of generating a fantasy match based on a real competitor, the method comprising:
a data processing arrangement accessing historical game data associated with a real competitor;
a data processing arrangement processing the received historical game data to calculate probability data;
a data processing arrangement accessing a gaming bot having variable play parameters; and
a data processing arrangement altering the variable play parameters based on the calculated probability data to create an altered gaming bot, so that behavior of the altered gaming bot during play of the fantasy match resembles behavior of the real competitor.

27. The computer-implemented method as claimed in claim 26, further comprising:
a data processing arrangement accessing a match environment for the fantasy match; and
a data processing arrangement causing the fantasy match to execute with the altered gaming bot in the match environment.

28. The computer-implemented method as claimed in claim 27, wherein accessing the match environment comprises creating the match environment.

29. The computer-implemented method as claimed in claim 26, wherein accessing the gaming bot comprises creating the gaming bot.

30. The computer-implemented method as claimed in claim 26, wherein the calculated probability data comprises conditional probability data associated with a second real competitor.

31. The computer-implemented method as claimed in claim 26, further comprising:
processing the historical game data to determine at least one weighting parameter; and
further altering the gaming bot based on the weighting parameter,
wherein the weighting parameter is associated with a second real competitor.

32. The computer-implemented method as claimed in claim 26, wherein the calculated probability data is multi-dimensional data representing a probability of occurrence of an event and a probability of effect of said event.

33. The computer-implemented method as claimed in claim 26, wherein the historical game data is associated with a historical completed game and not a current game.

34. The computer-implemented method as claimed in claim 26, wherein machine learning is used to update the gaming bot based on historical game data.

35. A computer-implemented method of generating a fantasy match based on a real competitor, the method comprising:
a data processing arrangement accessing historical game data associated with a real competitor;
a data processing arrangement creating at least one gaming bot having one or more variable play parameters based on probability data associated with the historical game data.

36. The computer-implemented method as claimed in claim 35, further comprising:
a data processing arrangement accessing a match environment for the fantasy match; and
a data processing arrangement causing the fantasy match to execute with the at least one gaming bot in the match environment.

37. The computer-implemented method as claimed in claim 35, wherein the fantasy match is executed in an e-sport environment.
